(19) United States
(12) Patent Application Publication
(10) Pub. No.: US 2026/0179845 A1
(43) Pub. Date: Jun. 25, 2026

(54) CAPACITOR

(71) Applicant: Panasonic Intellectual Property Management Co., Ltd., Osaka (JP)

(72) Inventors: YUTA YAMASAKI, Toyama (JP); TAKESHI IMAMURA, Toyama (JP); ERIKO KANATANI, Toyama (JP)

(21) Appl. No.: 19/385,229

(22) Filed: Nov. 11, 2025

(30) Foreign Application Priority Data
Dec. 23, 2024 (JP) 2024-226535

(51) Int. Cl. H01G 4/228; H01G 4/224

(52) U.S. Cl. CPC H01G 4/228; H01G 4/224

(57) ABSTRACT

A capacitor includes a capacitor element, a first bus bar and a second bus bar that are connected to the capacitor element, an insulating member disposed between the first bus bar and the second bus bar, a case housing the capacitor element, and a filling resin filled in the case. A part of each of the first bus bar, the second bus bar, and the insulating member is exposed from the filling resin. The insulating member includes a first facing surface and a first ridge portion. The first facing surface faces the first bus bar with a gap disposed between the insulating member and the first bus bar. The first ridge portion is in contact with the first bus bar.

### BACKGROUND

### 1. Technical Field

The present disclosure relates generally to a capacitor, and more particularly to a capacitor including a capacitor element.

### 2. Description of the Related Art

Unexamined Japanese Patent Publication No. 2018-182075 discloses a capacitor module including a capacitor element, a pair of bus bars connected to a positive electrode or a negative electrode of the capacitor element, an insulating plate that insulates the pair of bus bars from each other, and a resin package that seals a portion or the whole of these parts. The pair of bus bars partially face each other. The insulating plate is disposed between the pair of bus bars in a range where the pair of bus bars face each other. The insulating plate has protrusions near both ends of a contact surface with one of the pair of bus bars in a longitudinal direction of the contact surface. The one bus bar has holes for receiving the protrusions. At least one projection in contact with an inner peripheral side surface of each of the holes is disposed on a side surface of the protrusion in a state where the protrusion is inserted into the hole, and the insulating plate is fixed to the one bus bar by the at least one projection. The protrusions are sealed by the resin package.

### SUMMARY

A capacitor according to one aspect of the present disclosure includes a capacitor element, a first bus bar and a second bus bar that are connected to the capacitor element, an insulating member disposed between the first bus bar and the second bus bar, a case housing the capacitor element, and a filling resin filled in the case. A part of each of the first bus bar, the second bus bar, and the insulating member is exposed from the filling resin. The insulating member includes a first facing surface and a first ridge portion, the first facing surface facing the first bus bar with a gap disposed between the insulating member and the first bus bar, the first ridge portion being in contact with the first bus bar.

According to the present disclosure, it is possible to provide a capacitor capable of preventing a liquid resin from rising due to the capillary action of the liquid resin in a gap between a bus bar and an insulating member when injecting the liquid resin in a process of manufacturing the capacitor.

### BRIEF DESCRIPTION OF THE DRAWINGS

FIG. 1 is a perspective view illustrating a capacitor according to the present exemplary embodiment;

FIG. 2 is a perspective view (not illustrating a filling resin) illustrating the capacitor according to the present exemplary embodiment;

FIG. 3 is an exploded perspective view illustrating a portion of the capacitor according to the present exemplary embodiment;

FIG. 4 is a front view illustrating the capacitor according to the present exemplary embodiment;

FIG. 5 is a front view illustrating a portion of the capacitor according to the present exemplary embodiment;

FIG. 6 is a cross-sectional view taken along line A-A in FIG. 4; and

FIG. 7 is an enlarged cross-sectional view of a main part (a region B) illustrated in FIG. 6.

### DETAILED DESCRIPTIONS OF EMBODIMENTS

The problems in the conventional technology are briefly described below.

In the capacitor disclosed in Unexamined Japanese Patent Publication No. 2018-182075, when a liquid resin is filled in a process of manufacturing the capacitor, there is a possibility that the liquid resin may rise in a gap between the pair of bus bars and the insulating plate due to the capillary action of the liquid resin. In the capacitor as described above, there is a problem that it is difficult to prevent the liquid resin from rising due to the capillary action of the liquid resin. And thus there is a possibility of a leakage of the liquid resin to the outside of the capacitor and a positional deviation due to adhesion of a filling resin to a fastener for the bus bars.

The present disclosure provides a capacitor capable of preventing a liquid resin from rising due to the capillary action of the liquid resin in a gap between a bus bar and an insulating member when injecting the liquid resin in a process of manufacturing the capacitor.

### 1. Overview

By conducting intensive research to solve the problem of the capacitor module described in Unexamined Japanese Patent Publication No. 2018-182075 and a defect in the process of manufacturing the capacitor caused in association with this problem, the inventors have developed a capacitor described below.

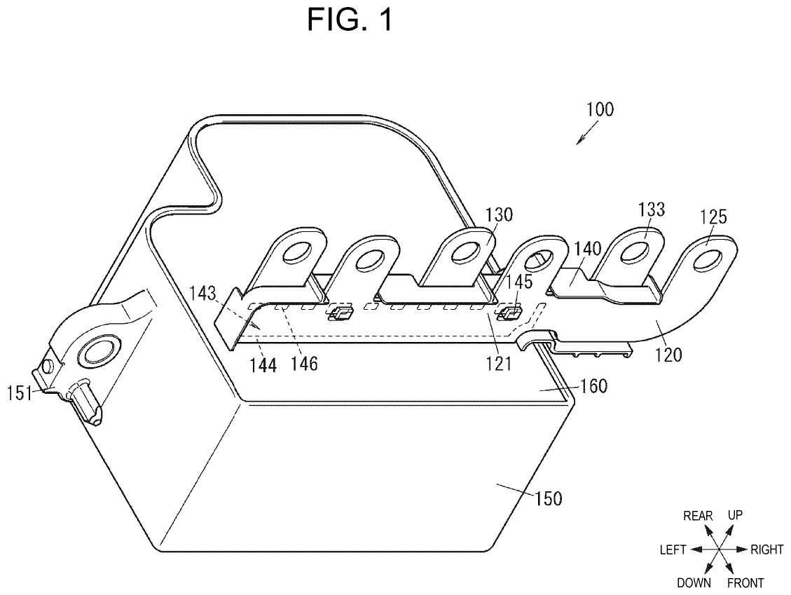

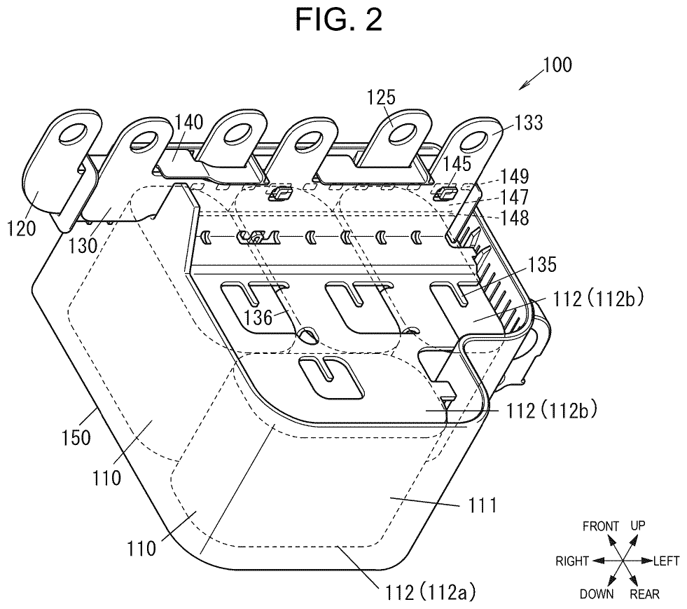

As illustrated in FIGS. 1 and 2, capacitor 100 according to the present exemplary embodiment includes capacitor element 110, first bus bar 120 and second bus bar 130 that are connected to capacitor element 110, insulating member 140 disposed between first bus bar 120 and second bus bar 130, case 150 housing capacitor element 110, and filling resin 160 filled in case 150. A part of each of first bus bar 120, second bus bar 130, and insulating member 140 is exposed from filling resin 160. Insulating member 140 includes first facing surface 143 facing first bus bar 120 with gap G1 disposed between insulating member 140 and first bus bar 120, and first ridge portion 144 in contact with first bus bar 120.

With capacitor 100 according to the present exemplary embodiment as described above, it is possible to prevent a liquid resin from rising due to the capillary action of the liquid resin in gap G1 between first bus bar 120 and insulating member 140 when the liquid resin is injected to case 150 in a process of manufacturing capacitor 100. Thus, it is possible to prevent the occurrence of defects such as an appearance defect of capacitor 100, adhesion of capacitor 100 to a manufacturing facility due to filling resin 160, or the like by leakage of the liquid resin to the outside of capacitor 100. Further, it is possible to prevent the occurrence of a positional deviation due to the adhesion of filling resin 160 to fastener 145 of insulating member 140, and thus it is possible to prevent a dimensional defect, variation, and the like of capacitor 100.

### 2. Exemplary Embodiments

### (1) Capacitor

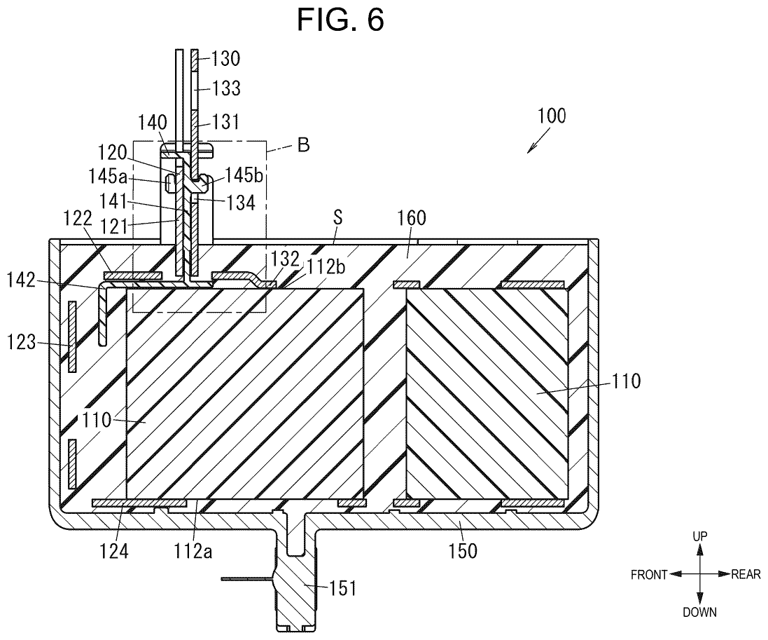

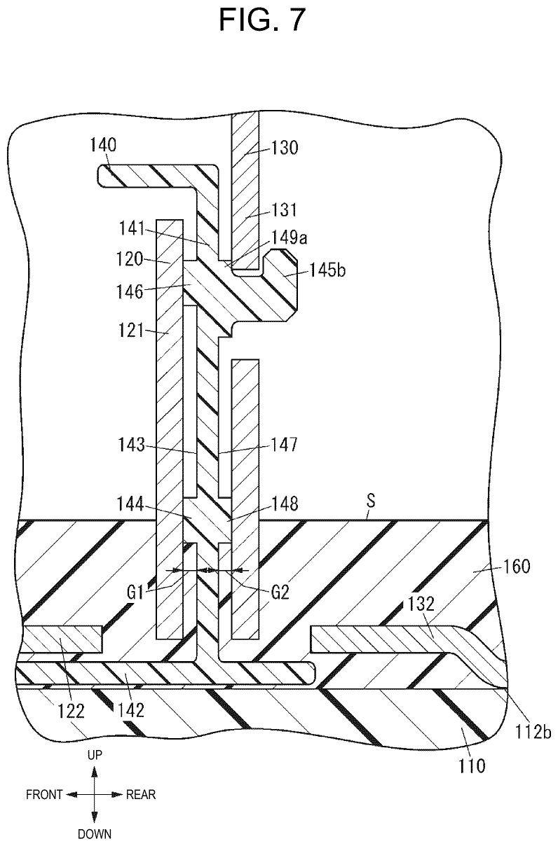

Capacitor 100 according to the present exemplary embodiment will be described below with reference to FIGS. 1 to 7. Each drawing is a schematic diagram, and the ratio of each of the size and the thickness of each component in each drawing does not necessarily reflect the actual dimensional ratio. In particular, in FIG. 7, some parts are exaggerated for easy description. Arrows indicating respective directions in each of the drawings are not intended to define the directions of capacitor 100 at the time of use, but are merely written for easy understanding of the description, and do not represent the actual state. In FIGS. 1 to 7, an up-and-down direction, a left-right direction, and a front-rear direction are defined. These directions are orthogonal to each other. A view viewed in the up-and-down direction may be referred to as “plan view”, a view viewed in the left-right direction may be referred to as “side view”, and a view viewed in the front-rear direction may be referred to as “front view”.

### (Configuration)

As illustrated in FIGS. 1 and 2, capacitor 100 according to the present exemplary embodiment includes capacitor element 110, first bus bar 120, second bus bar 130, insulating member 140, case 150, and filling resin 160.

### <Capacitor Element>

Capacitor 100 includes at least one capacitor element 110. Capacitor element 110 is not particularly limited, and examples thereof include a wound or laminated film capacitor element. Capacitor element 110 includes element main body 111 and electrode part 112.

The shape of element main body 111 is not particularly limited, but in the present exemplary embodiment, element main body 111 has a rounded rectangular shape in plan view and a rounded rectangular column shape in front view and side view. Although not illustrated, in element main body 111, a pair of internal electrodes face each other with a dielectric material such as a polymer film interposed between the internal electrodes.

The material of the internal electrodes is not particularly limited, and examples thereof include aluminum (Al), gold (Au), magnesium (Mg), tin (Sn), nickel (Ni), chromium (Cr), iron (Fe), copper (Cu), titanium (Ti), and alloys containing these metals.

The material of the polymer film used as the dielectric material is not particularly limited, and examples thereof include polypropylene (PP), polyethylene terephthalate (PET), polyethylene naphthalate (PEN), polyphenylene sulfide (PPS), polycarbonate (PC), and polystyrene (PS).

Electrode part 112 is formed on both end surfaces of element main body 111 by, for example, metal spraying. In the present exemplary embodiment, the end surfaces of element main body 111 are an upper surface and a lower surface. That is, electrode part 112 has a rounded rectangular shape. A metal used as electrode part 112 is not particularly limited, and examples thereof include zinc (Zn), tin (Sn), and alloys containing these metals.

The number of capacitor elements 110 included in capacitor 100 is not particularly limited. In the present exemplary embodiment, capacitor 100 includes four capacitor elements 110. Four capacitor elements 110 are arranged vertically with electrode parts 112 facing in the up-and-down direction. Among four capacitor elements 110, three capacitor elements 110 are arranged to be aligned in the left-right direction such that a long side of electrode part 112 of each capacitor element 110 extend in the front-rear direction. Remaining one capacitor element 110 is arranged to be disposed rear three capacitor elements 110 such that a long side of electrode part 112 of capacitor element 110 extends in the left-right direction. Right ends of three capacitor elements 110 and a right end of remaining one capacitor element 110 are aligned in a straight line. In a case where capacitor 100 includes a plurality of capacitor elements 110, the arrangement of capacitor elements 110 is not particularly limited.

### <First Bus Bar>

First bus bar 120 is a conductor member. The material of first bus bar 120 is not particularly limited, and examples thereof include copper (Cu), aluminum (Al), and alloys of these metals.

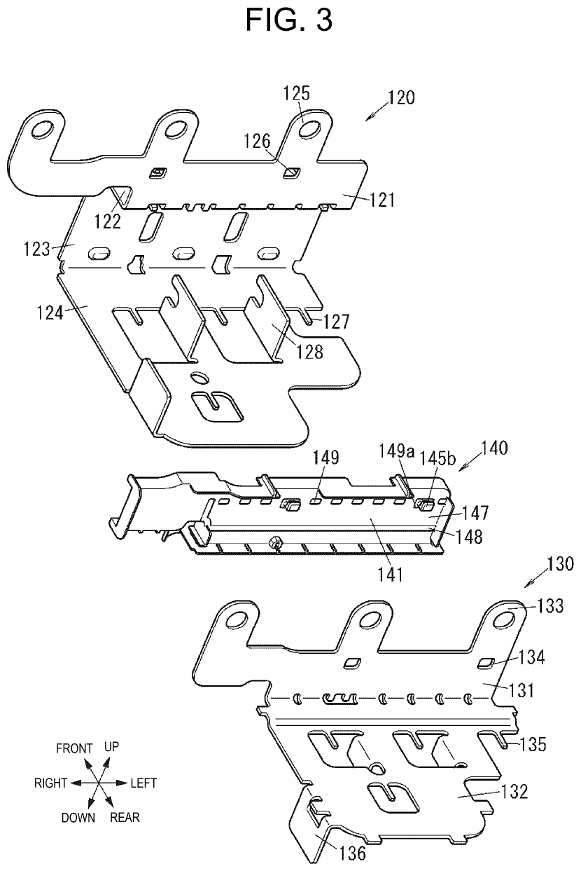

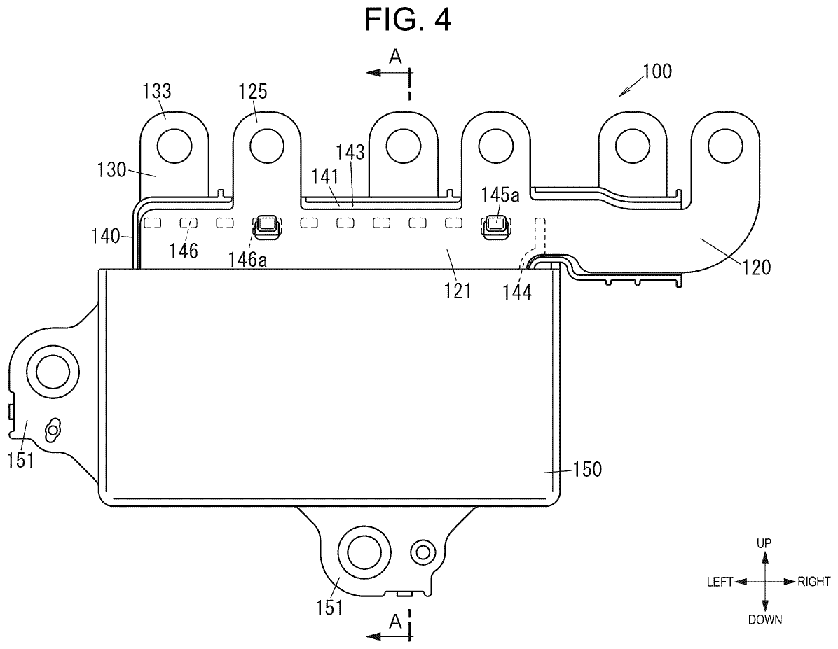

As illustrated in FIG. 3, in side view from the right side, first bus bar 120 has a shape obtained by combining an inverted L-shaped portion disposed on the upper side and an L-shaped portion disposed on the lower side. The upper inverted L-shaped portion includes first plate 121 and second plate 122. First plate 121 is a plate-like portion that extends in the up-and-down direction and the left-right direction, and second plate 122 is a plate-like portion that extends in the front-rear direction and the left-right direction is second plate 122. The lower L-shaped portion includes third plate 123 and fourth plate 124. Third plate 123 is a plate-like portion that extends in the up-and-down direction and the left-right direction, and fourth plate 124 is a plate-like portion that extends in the front-rear direction and the left-right direction. Further, for example, as illustrated in FIGS. 1 and 4, first plate 121 may further protrude and extend in the left-right direction than the other plate-like portions (122, 123, and 124).

First bus bar 120 faces second bus bar 130 with insulating member 140 interposed therebetween in the front-rear direction. Specifically, first plate 121 of first bus bar 120 faces first plate 131 of second bus bar 130 with insulating member 140 interposed therebetween in the front-rear direction. Fourth plate 124 of first bus bar 120 faces second plate 132 of second bus bar 130 with capacitor element 110 interposed therebetween in the up-and-down direction.

First bus bar 120 includes external terminal 125, insertion hole 126, internal terminal 127, and element guide plate 128. External terminal 125, insertion hole 126, internal terminal 127, and element guide plate 128 are integrated. First bus bar 120 is formed by, for example, punching and bending a metal plate into a desired shape.

External terminal 125 is electrically connected to an external device (not illustrated). The external device is not particularly limited, and examples thereof include components constituting an inverter. That is, capacitor 100 can be a part of the inverter, for example. The positions and the number of external terminals 125 are not particularly limited, but in the present exemplary embodiment, three external terminals 125 are disposed in an upper part of first plate 121.

Fastener 145a of insulating member 140 described later is inserted into insertion hole 126 to lock first bus bar 120 and insulating member 140. The positions and the number of insertion holes 126 are not particularly limited, but in the present exemplary embodiment, one insertion hole is disposed below each of two left external terminals 125 in first plate 121. In the present disclosure, “locking” means engaging and stopping.

Internal terminal 127 is connected to lower electrode part 112a. Specifically, four internal terminals 127 correspond one-to-one to lower electrode parts 112a of four capacitor elements 110. That is, first bus bar 120 includes internal terminals 127 as many as capacitor elements 110. Internal terminals 127 are connected to electrode parts 112a by, for example, welding, soldering, or the like. Internal terminals 127 protrude and extend in one direction in a punched portion and a notched portion of fourth plate 124. In the present exemplary embodiment, internal terminal 127 protrudes and extends rearward from a front side of each of the punched portion and the notched portion of fourth plate 124.

Element guide plate 128 extends upward in the normal direction of fourth plate 124 of first bus bar 120. Element guide plate 128 is disposed between adjacent capacitor elements 110, and may be present like a partition plate. Element guide plate 128 may be disposed on an outer periphery of fourth plate 124. An arrangement form of element guide plate 128 is not particularly limited. Meanwhile, in the present exemplary embodiment, each of two element guide plates 128 is disposed between adjacent capacitor elements 110 among three capacitor elements 110 arranged in the left-right direction, and one element guide plate 128 is disposed on right and rear side of an outer periphery of capacitor element 110. Element guide plate 128 may or may not be in contact with capacitor element 110.

### <Second Bus Bar>

Second bus bar 130 is a conductor member similarly to first bus bar 120. The material of second bus bar 130 is also similar to that of first bus bar 120.

As illustrated in FIG. 3, in side view from the right side, second bus bar 130 includes an L-shaped portion. The L-shaped portion includes first plate 131 and second plate 132. First plate 131 is a plate-like portion that extends in the up-and-down direction and the left-right direction is first plate 131, and second plate 132 is a plate-like portion that extends in the front-rear direction and the left-right direction. Further, as illustrated in FIGS. 2 and 4, first plate 131 may further protrude and extend in the left-right direction than second plate 132.

As described above, second bus bar 130 faces first bus bar 120 with insulating member 140 interposed therebetween in the front-rear direction.

Similarly to first bus bar 120, second bus bar 130 includes external terminal 133, insertion hole 134, internal terminal 135, and element guide plate 136. External terminal 133, insertion hole 134, internal terminal 135, and element guide plate 136 are integrated. Second bus bar 130 is formed in a similar manner to first bus bar 120, for example.

Similarly to external terminal 125, external terminal 133 is electrically connected to an external device (not illustrated). The positions and the number of external terminals 133 are not particularly limited, but in the present exemplary embodiment, three external terminals 133 are disposed in an upper part of first plate 131.

Similarly to insertion hole 126, fastener 145b of insulating member 140 is inserted into insertion hole 134 to lock second bus bar 130 and insulating member 140. The positions and the number of insertion holes 134 are not particularly limited, but in the present exemplary embodiment, one insertion hole is disposed below each of two left external terminals 133 in first plate 131.

Internal terminal 135 is connected to upper electrode part 112b. Specifically, four internal terminals 135 correspond one-to-one to electrode parts 112b of four capacitor elements 110. That is, second bus bar 130 has internal terminals 135 as many as capacitor elements 110. The connection between internal terminal 135 and electrode part 112b is, for example, similar to the connection between internal terminal 127 and electrode part 112a. Internal terminal 135 protrudes and extends in one direction in each of a punched portion and a notched portion of second plate 132. In the present exemplary embodiment, internal terminal 135 protrudes and extends rearward from a front side of each of the punched portion and the notched portion of second plate 132.

Element guide plate 136 extends downward in the normal direction of second plate 132. Element guide plate 136 is disposed between adjacent capacitor elements 110, and may be present like a partition plate. Element guide plate 136 may be disposed on an outer periphery of second plate 132. An arrangement form of element guide plate 136 is not particularly limited, but in the present exemplary embodiment, similarly to element guide plate 128, each of two element guide plates 136 is disposed between adjacent capacitor elements 110 among three capacitor elements 110 arranged in the left-right direction, and one element guide plate 136 is disposed on right and rear side of the outer periphery of capacitor element 110. In the present exemplary embodiment, each of element guide plates 128 and corresponding one of element guide plates 136 are arranged in the up-and-down direction in each arrangement. Element guide plate 136 may or may not be in contact with capacitor element 110.

### <Insulating Member>

Insulating member 140 has an electrical insulation property. The material of insulating member 140 is not particularly limited, and examples thereof include polyphenylene sulfide (PPS). Insulating member 140 includes interposed part 141 and element guide part 142.

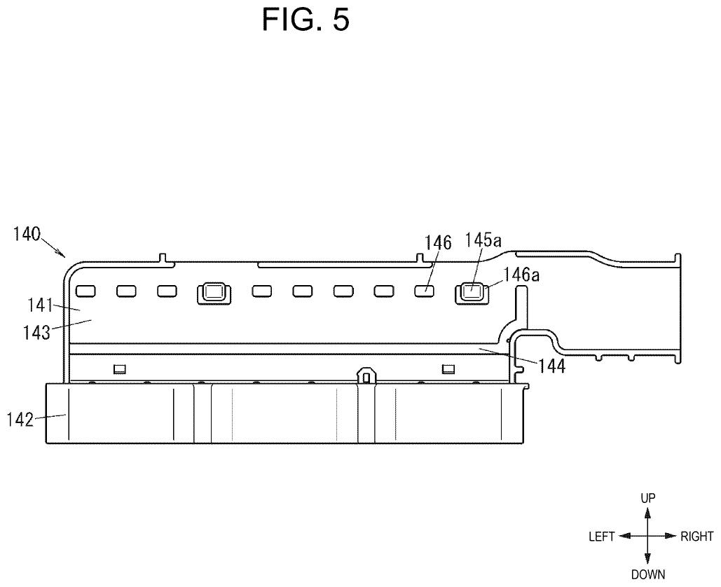

Interposed part 141 is disposed so as to be interposed between first bus bar 120 and second bus bar 130. Specifically, interposed part 141 is disposed so as to be interposed between first plate 121 of first bus bar 120 and first plate 131 of second bus bar 130. Further, as illustrated in FIGS. 1 and 5, interposed part 141 may further protrude and extend in the left-right direction than element guide part 142.

As illustrated in FIGS. 5, 6, and 7, insulating member 140 includes, in interposed part 141, first facing surface 143 facing first bus bar 120 with gap G1 interposed between insulating member 140 and first bus bar 120, and first ridge portion 144 in contact with first bus bar 120.

Specifically, first facing surface 143 faces a rear surface of first plate 121 of first bus bar 120 with gap G1 disposed therebetween. The size of gap G1 is not particularly limited, but is, for example, greater than or equal to 0.05 mm and less than or equal to 1.0 mm.

First ridge portion 144 is in contact with first bus bar 120. First ridge portion 144 has a rectangular band shape having a short side in the up-and-down direction, a long side in the left-right direction, and a thickness in the front-rear direction on first facing surface 143. The long side of first ridge portion 144 is parallel to the coordinate axis in the left-right direction. The thickness of first ridge portion 144 is similar to the size of gap G1. That is, first ridge portion 144 is interposed between first plate 121 and first facing surface 143, and a front part of first ridge portion 144 is in contact with first plate 121. First ridge portion 144 has approximately the same length as that of element guide part 142 in the left-right direction. That is, the length of first ridge portion 144 is approximately the same as the length from the left end to the right end of element guide part 142.

First ridge portion 144 may further includes a part extending upward in a straight line from a position above the right end of element guide part 142. In the present exemplary embodiment, a height position (position in the up-and-down direction) of its upper end of the part extending upward in first ridge portion 144 is approximately the same as a height position of fastener 145a described later.

Meanwhile, there is no first ridge portion 144 in a part of interposed part 141 that further protrudes and extends right with respect to element guide part 142.

First ridge portion 144 may be integrally formed as a part of insulating member 140, or may be separately formed from insulating member 140 and integrated with insulating member 140 by bonding or the like. In a case where first ridge portion 144 is separately formed, the material of first ridge portion 144 is not particularly limited, and examples thereof include a resin member made of polyphenylene sulfide (PPS) or the like, an adhesive, an adhesive tape, a non-adhesive tape, and the like.

As illustrated in FIGS. 5, 6, and 7, insulating member 140 may include at least one projection 146 on first facing surface 143.

Projection 146 is in contact with first bus bar 120. The number and shape of projections 146 are not particularly limited, and examples of the shape include a columnar shape, a cone shape, and a frustum shape. The columnar shape may be one rectangular band shape having a thickness in the front-rear direction similarly to first ridge portion 144, or may be a plurality of columnar shapes, conical shapes, or frustum shapes having a thickness in the front-rear direction. In the present exemplary embodiment, projection 146 has a plurality of rounded rectangular columnar shapes having a thickness in the front-rear direction. The thickness of projection 146 is similar to the size of gap G1. That is, similarly to first ridge portion 144, projection 146 is interposed between first plate 121 and first facing surface 143, and a front part of projection 146 is in contact with first plate 121. The total area of surfaces of a plurality of projections 146 in contact with first plate 121 is preferably less than or equal to the area of a surface of first ridge portion 144 in contact with first plate 121.

The plurality of projections 146 are aligned parallel to the coordinate axis in the left-right direction, and are arranged in a straight line to form a row. That is, the row of projections 146 is parallel to the long side of first ridge portion 144 in the left-right direction. Projection 146 is disposed above an opening of case 150. Therefore, projection 146 is also disposed above first ridge portion 144.

A part of projection 146 may have projection 146a arranged side by side with fastener 145a in the front-rear direction. That is, projection 146a and fastener 145a may be formed in this order from interposed part 141 toward the front side. In a case where projection 146a and fastener 145a are arranged side by side, projection 146a is larger than insertion hole 126 at least in either the left-right direction or the up-and-down direction. As a result, projection 146a can be in contact with first bus bar 120.

The sum of the area of the surface of first ridge portion 144 in contact with first plate 121 and the area of the surface of projection 146 in contact with first plate 121 is preferably less than or equal to half the area of first facing surface 143.

Similarly to first ridge portion 144, projection 146 may be integrally formed as a part of insulating member 140, or may be separately formed from insulating member 140 and integrated with insulating member 140 by bonding or the like. In a case where projection 146 is separately formed, the material of projection 146 is similar to that of first ridge portion 144.

As illustrated in FIGS. 3, 6, and 7, insulating member 140 may further include, in interposed part 141, second facing surface 147 facing second bus bar 130 with gap G2 disposed between insulating member 140 and second bus bar 130, and second ridge portion 148 in contact with second bus bar 130.

Second facing surface 147 has substantially the same features as those of first facing surface 143. Differences between second facing surface 147 and first facing surface 143 are as follows. Specifically, second facing surface 147 faces a front surface of first plate 131 of second bus bar 130 with gap G2 disposed therebetween. The size of gap G2 is not particularly limited, but is approximately the same as that of gap G1, and is, for example, greater than or equal to 0.05 mm and less than or equal to 1.0 mm in a second exemplary embodiment.

Second ridge portion 148 on second facing surface 147 is mirror symmetrical to first ridge portion 144 on first facing surface 143, and has substantially the same features as those of first ridge portion 144. Differences between second ridge portion 148 and first ridge portion 144 are as follows. Second ridge portion 148 is in contact with second bus bar 130. The thickness of second ridge portion 148 is similar to the size of gap G2. That is, second ridge portion 148 is interposed between first plate 131 and second facing surface 147, and a rear portion of second ridge portion 148 is in contact with first plate 131.

As illustrated in FIG. 3, insulating member 140 may further include at least one projection 149 on second facing surface 147. Projection 149 on second facing surface 147 has substantially the same features as projection 146 on first facing surface 143. Differences between projection 149 and projection 146 are as follows. Projection 149 is in contact with second bus bar 130. That is, similarly to second ridge portion 148, projection 149 is interposed between first plate 131 and second facing surface 147, and a rear part of projection 149 is in contact with first plate 131. The total area of surfaces of a plurality of projections 149 in contact with first plate 131 is preferably less than or equal to the area of a surface of second ridge portion 148 in contact with first plate 131. Projection 149 is disposed above the opening of case 150. Therefore, projection 149 is disposed above second ridge portion 148.

Projections 149 may include projection 149a arranged side by side with fastener 145b described later in the front-rear direction. That is, projection 149a and fastener 145b may be formed in this order from interposed part 141 toward the rear side. In a case where projection 149a and fastener 145b are arranged side by side, projection 149a is larger than insertion hole 134 at least in either the left-right direction or the up-and-down direction. As a result, projection 149a can be in contact with second bus bar 130.

The sum of the area of the surface of second ridge portion 148 in contact with first plate 131 and the area of the surface of projection 149 in contact with first plate 131 is preferably less than or equal to half the area of second facing surface 147.

Projection 146 and projection 149 may be disposed so as to overlap each other in the front-rear direction with interposed part 141 interposed therebetween, may be disposed so as to partially overlap each other, or may be disposed so as not to overlap each other. The positions of projection 146 and projection 149 in the up-and-down direction may be the same or different.

Insulating member 140 includes fasteners 145 (145a and 145b) protruding forward and rearward in interposed part 141. That is, insulating member 140 includes fastener 145a on first facing surface 143 and fastener 145b on second facing surface 147. The shapes of fasteners 145 are not particularly limited, but in the present exemplary embodiment, each of fasteners 145 has an L shape in side view and a rectangular shape in front view and plan view. As described above, fasteners 145 are inserted into insertion holes 126 and 134, and lock first bus bar 120 and second bus bar 130. In the present exemplary embodiment, two fasteners 145 are disposed on the front side, two fasteners 145 are disposed on the rear side, and fasteners 145 correspond one-to-one to two insertion holes 126 and two insertion holes 134. That is, interposed part 141 includes fasteners 145 as many as the total number of insertion holes 126 and insertion holes 134. Fasteners 145 are disposed above first ridge portion 144 and are exposed from filling resin 160.

Element guide part 142 is interposed between first bus bar 120 and upper electrode portion 112b, and is a part that clearly indicates a position where capacitor element 110 is disposed at the time of manufacturing capacitor 100. Specifically, element guide part 142 is interposed so as to face upper parts of second plate 122 and third plate 123 of first bus bar 120. A front part of element guide part 142 may have an arch shape. Element guide part 142 may or may not be in contact with capacitor element 110.

### <Case>

Case 150 houses capacitor element 110. In the present exemplary embodiment, case 150 houses four capacitor elements 110. Case 150 houses a part of each of first bus bar 120, second bus bar 130, and insulating member 140. Further, case 150 is open at the top. Therefore, the part of each of first bus bar 120, second bus bar 130, and insulating member 140 is housed in case 150, and a part of each of first bus bar 120, second bus bar 130, and insulating member 140 that is not housed is exposed upward from the opening side of case 150.

The material of case 150 is not particularly limited, and examples thereof include polyphenylene sulfide (PPS), polybutylene terephthalate (PBT), and an epoxy resin (EP).

Case 150 may have at least one mounting portion. In the present exemplary embodiment, a left surface and a lower surface of case 150 each have one mounting portion (see FIG. 5).

### <Filling Resin>

Filling resin 160 is a cured product of a liquid resin, and has an electrical insulation property. The material of the liquid resin is not particularly limited, and examples thereof include a thermosetting resin and a photocurable resin. More specifically, examples thereof include an epoxy resin.

Case 150 is filled with filling resin 160 (see FIG. 1). Surface S (hereinafter, also referred to as an exposed surface S) of filling resin 160 that is not in contact with case 150 is located slightly below the opening of case 150. Exposed surface S is parallel to the coordinate axes in the left-right direction and the front-rear direction. That is, exposed surface S, the long side of first ridge portion 144, the row of the plurality of projections 146, second ridge portion 148, and the plurality of projections 149 are parallel to each other in the left-right direction.

As described above, capacitor element 110 is housed in case 150, and therefore is present in filling resin 160. Since the part of each of first bus bar 120, second bus bar 130, and insulating member 140 is housed in case 150, the part of each of first bus bar 120, second bus bar 130, and insulating member 140 is present in filling resin 160, and the remaining part of each of first bus bar 120, second bus bar 130, and insulating member 140 is exposed from filling resin 160. In other words, filling resin 160 seals capacitor element 110 and the part of each of first bus bar 120, second bus bar 130, and insulating member 140. Specifically, external terminals 125 and 133 and insertion holes 126 and 134 of respective first bus bar 120 and second bus bar 130, and at least a part of first ridge portion 144 of insulating member 140 are exposed. In the present exemplary embodiment, as illustrated in FIG. 7, filling resin 160 is filled up to the height of a lower surface of first ridge portion 144 in gap G1, and an upper surface and a front surface of first ridge portion 144 are not present in filling resin 160 and are exposed from filling resin 160. As described above, projection 146 is disposed above first ridge portion 144. That is, projection 146 is disposed farther (upward) from filling resin 160 than first ridge portion 144. Similarly, filling resin 160 is filled up to the height of a lower surface of second ridge portion 148 in gap G2, and an upper surface and a front surface of second ridge portion 148 are not present in filling resin 160 and are exposed from filling resin 160. As described above, projection 149 is disposed above second ridge portion 148. That is, projection 149 is disposed farther (upward) from filling resin 160 than second ridge portion 148.

The position of each of first ridge portion 144 and second ridge portion 148 in the up-and-down direction is not particularly limited. In the present exemplary embodiment, exposed surface S is located between the upper surface and the lower surface of each of first ridge portion 144 and second ridge portion 148.

### (Manufacturing Method)

A method for manufacturing capacitor 100 according to the present exemplary embodiment will be described.

First, by inserting fasteners 145 into insertion holes 126 and 134, insulating member 140 is combined with first bus bar 120 and second bus bar 130. Next, capacitor element 110 is arranged such that internal terminals 127 and 135 are connected to electrode parts 112a and 112b, respectively, in accordance with element guide part 142 of insulating member 140 and positioning portions of first bus bar 120 and second bus bar 130. Next, capacitor element 110 is housed in case 150, and the liquid resin is injected into case 150 by a cast molding method. Subsequently, the injected liquid resin is cured to obtain filling resin 160. In this manner, capacitor 100 as illustrated in FIG. 1 is manufactured.

### (2) Effects

Capacitor 100 according to the present exemplary embodiment can prevent the liquid resin from rising due to the capillary action of the liquid resin in gap G1 between first bus bar 120 and insulating member 140 when the liquid resin is injected to case 150 in the process of manufacturing capacitor 100. Similarly, when the liquid resin is injected in the process of manufacturing capacitor 100, it is possible to prevent the liquid resin from rising due to the capillary action of the liquid resin in gap G2 between second bus bar 130 and insulating member 140.

If capacitor 100 does not have first ridge portion 144 and second ridge portion 148, when the liquid resin is injected into gaps G1 and G2, there is a possibility that the liquid resin may not stay at the liquid level (corresponding to exposed surface S of the filling resin) of the liquid resin due to the capillary action and may rise upward from the liquid level. When the liquid resin that has risen leaks out from above gaps G1 and G2, filling resin 160 may adhere to an undesired portion, and thus there is a possibility that an appearance defect of capacitor 100 may occur. As illustrated in FIG. 1, in a case where capacitor 100 includes first bus bar 120, second bus bar 130, and insulating member 140 that protrude outside case 150, the liquid resin may leak out of capacitor 100 through gaps G1 and G2 due to the capillary action. If the liquid resin leaks to the outside of capacitor 100, not only an appearance defect of capacitor 100 may occur, but also a production defect due to the adhesion of filling resin 160 to capacitor 100 and the manufacturing facility may occur. Further, when the liquid resin is cured while rising above the liquid level and adhesion of filling resin 160 occurs, there is a possibility that a positional deviation of fastener 145 of insulating member 140 may occur. When such a positional deviation occurs, a defect such as a dimensional defect of capacitor 100 or a large dimensional variation of capacitor 100 also occurs.

In the present exemplary embodiment, insulating member 140 of capacitor 100 includes first ridge portion 144 that is in contact with first bus bar 120 in gap G1 and second ridge portion 148 that is in contact with second bus bar 130 in gap G2. Since insulating member 140 includes first ridge portion 144 and second ridge portion 148, gaps G1 and G2 are closed, and it is possible to prevent the liquid resin from rising above first ridge portion 144 and second ridge portion 148 due to the capillary action. Therefore, since the occurrence of leakage of the liquid resin to the outside of capacitor 100 is prevented, the occurrence of an appearance defect of capacitor 100, a manufacturing defect in the manufacture of capacitor 100, and a dimensional defect of capacitor 100 can be prevented.

In the present exemplary embodiment, insulating member 140 further includes projection 146 spaced from exposed surface S and disposed higher than first ridge portion 144. Projection 146 is in contact with first bus bar 120. As a result, first bus bar 120 can be prevented from warping toward insulating member 140. Similarly, insulating member 140 further includes projection 149 spaced from exposed surface S and disposed higher than second ridge portion 148. Projection 149 is in contact with second bus bar 130. As a result, second bus bar 130 can be prevented from warping toward insulating member 140. As described above, by preventing each of the first bus bar and second bus bar 130 from warping, a dimensional variation of capacitor 100 can be prevented.

Further, in the present exemplary embodiment, the area of a part of projection 146 in contact with first bus bar 120 is less than or equal to the area of a part of first ridge portion 144 in contact with first bus bar 120. As a result, the contact pressure between first bus bar 120 and projection 146 is higher than or equal to the contact pressure between first bus bar 120 and first ridge portion 144. Therefore, since projection 146 is more likely to come into contact with first bus bar 120 than first ridge portion 144, first bus bar 120 can be further prevented from warping. Similarly, the area of a part of projection 149 in contact with second bus bar 130 is less than or equal to the area of a part of second ridge portion 148 in contact with second bus bar 130. As a result, the contact pressure between second bus bar 130 and projection 149 is higher than or equal to the contact pressure between second bus bar 130 and second ridge portion 148. Therefore, since projection 149 is more likely to come into contact with second bus bar 130 than second ridge portion 148, warping of second bus bar 130 can be further prevented. In addition, reducing the contact area between first bus bar 120 and projection 146 and the contact area between second bus bar 130 and projection 149 contributes to thinning of insulating member 140. As a result, it is possible to prevent the occurrence of warpage of insulating member 140 due to manufacturing. As described above, by preventing each of first bus bar 120 and second bus bar from warping and preventing insulating member 140 from warping, a dimensional variation of capacitor 100 can be further prevented.

In the present exemplary embodiment, the sum of the area of the part of first ridge portion 144 in contact with first bus bar 120 and the area of the part of projection 146 in contact with first bus bar 120 is less than or equal to half the area of first facing surface 143. As a result, the contact pressure between first bus bar 120, and first ridge portion 144 and projection 146 increases. Therefore, first bus bar 120 and first ridge portion 144 are likely to come into contact with each other, and when the liquid resin is injected in the process of manufacturing capacitor 100, it is possible to prevent the liquid resin from rising due to the capillary action of the liquid resin in gap G1 between first bus bar 120 and insulating member 140. Similarly, the sum of the area of the part of second ridge portion 148 in contact with second bus bar 130 and the area of the part of projection 149 in contact with second bus bar 130 is less than or equal to half the area of second facing surface 147. As a result, the contact pressure between second bus bar 130, and second ridge portion 148 and projection 149 increases. Therefore, second bus bar 130 and second ridge portion 148 easily come into contact with each other, and when the liquid resin is injected in the process of manufacturing capacitor 100, it is possible to prevent the liquid resin from rising due to the capillary action of the liquid resin in gap G2 between second bus bar 130 and insulating member 140. In addition, if it is attempted to prevent the liquid resin from rising due to the capillary action of the liquid resin in gaps G1 and G2 by providing recesses in each of first facing surface 143 and second facing surface 147 of insulating member 140, it is necessary to form the recesses deep to the extent that the capillary action does not occur, and thus it is necessary to increase the thickness of interposed part 141. On the other hand, in the present exemplary embodiment, since first ridge portion 144 and projection 146 are formed so as to protrude forward from first facing surface 143, and second ridge portion 148 and projection 149 are formed so as to protrude rearward from second facing surface 147, first ridge portion 144, projection 146, second ridge portion 148, and projection 149 are not affected by the thickness of interposed part 141. That is, since the thickness of interposed part 141 can be reduced, this contributes to thinning of insulating member 140, and the occurrence of warpage of insulating member 140 due to the manufacturing can be prevented. The thickness of interposed part 141 means a distance between first facing surface 143 and second facing surface 147 in the front-rear direction.

### 3. Modifications

The exemplary embodiments described above are merely some of various exemplary embodiments of the present disclosure. As long as the object of the present disclosure can be achieved, the present disclosure is not limited to the above-described exemplary embodiments, and various modifications can be made according to design and the like.

In capacitor 100 according to Modification 1, insulating member 140 includes first facing surface 143 that faces first bus bar 120 with gap G1 disposed between insulating member 140 and first bus bar 120, first ridge portion 144 that is in contact with first bus bar 120, second facing surface 147 that faces second bus bar 130 with gap G2 disposed between insulating member 140 and second bus bar 130, and second ridge portion 148 that is in contact with second bus bar 130. That is, insulating member 140 does not include projection 146 and projection 149. Even in this case, capacitor 100 can prevent the liquid resin from rising due to the capillary action of the liquid resin in gap G1 between the first bus bar and the insulating member and gap G2 between the second bus bar and the insulating member when the liquid resin is injected in the process of manufacturing capacitor 100.

Further, in Modification 1, insulating member 140 may have projection 146 or projection 149. In a case where projection 146 is provided, first bus bar 120 in contact with projection 146 can be prevented from warping toward insulating member 140. Further, the area of the part of projection 146 in contact with first bus bar 120 is less than or equal to the area of the part of first ridge portion 144 in contact with first bus bar 120, and the contact pressure of projection 146 on first bus bar 120 is higher than or equal to the contact pressure of first ridge portion 144 on first bus bar 120. Therefore, since projection 146 is more likely to come into contact with first bus bar 120 than first ridge portion 144, first bus bar 120 can be further prevented from warping. In addition, reducing the contact area of projection 146 with first bus bar 120 contributes to thinning of insulating member 140, and thus the occurrence of warpage of insulating member 140 due to manufacturing can be prevented. As described above, by preventing warpage of first bus bar 120 and warpage of insulating member 140, a dimensional variation of capacitor 100 can be further prevented. In a case where projection 149 is provided, second bus bar 130 in contact with projection 149 can be prevented from warping toward insulating member 140. Further, the area of the part of projection 149 in contact with second bus bar 130 is less than or equal to the area of the part of second ridge portion 148 in contact with second bus bar 130, and the contact pressure of projection 149 on second bus bar 130 is higher than or equal to the contact pressure of second ridge portion 148 on second bus bar 130. Therefore, since projection 149 is more likely to come into contact with second bus bar 130 than second ridge portion 148, warping of second bus bar 130 can be further prevented. In addition, reducing the contact area of projection 149 with second bus bar 130 contributes to thinning of insulating member 140, and thus the occurrence of warpage of insulating member 140 due to manufacturing can be prevented. As described above, by preventing warpage of second bus bar 130 and warpage of insulating member 140, a dimensional variation of capacitor 100 can be further prevented.

Further, filling resin 160 is filled up to the heights of the lower surfaces of first ridge portion 144 and second ridge portion 148 in the first and second exemplary embodiments and Modification 1, but the present disclosure is not limited thereto. It is sufficient that at least parts of first ridge portion 144 and second ridge portion 148 are exposed from filling resin 160, and in gaps G1 and G2, the height of filling resin 160 may be less than or equal to the heights of the upper surfaces of first ridge portion 144 and second ridge portion 148, and may be below the lower surfaces of first ridge portion 144 and second ridge portion 148.

### 4. Aspects

As apparent from the above-described exemplary embodiments, the present disclosure includes the following aspects. In the following description, reference signs are given in parentheses only to clarify the correspondence relationship with the exemplary embodiments.

A first aspect is a capacitor (100) including: a capacitor element (110); a first bus bar (120) and a second bus bar (130) that are connected to the capacitor element (110); an insulating member (140) disposed between the first bus bar (120) and the second bus bar (130); a case (150) housing the capacitor element (110); and a filling resin (160) filled in the case (150). A part of each of the first bus bar (120), the second bus bar (130), and the insulating member (140) is exposed from the filling resin (160). The insulating member (140) includes a first facing surface (143) and a first ridge portion (144), the first facing surface (143) facing the first bus bar (120) with a gap (G1) disposed between the insulating member (140) and the first bus bar (120), the first ridge portion (144) being in contact with the first bus bar (120).

According to this aspect, when a liquid resin is filled in the capacitor (100) in a process of manufacturing the capacitor (100), it is possible to prevent the liquid resin from rising due to the capillary action of the liquid resin in the gap (G1) between the first bus bar (120) and the insulating member (140).

A second aspect is the capacitor (100) based on the first aspect. In the second aspect, the first ridge portion (144) extends parallel to a surface(S) of the filling resin (160), the surface(S) being not in contact with the case (150).

According to this aspect, when the liquid resin is filled in the capacitor (100) in the manufacturing process, it is possible to further prevent the liquid resin from rising due to the capillary action of the liquid resin in the gap (G1) between the first bus bar (120) and the insulating member (140).

A third aspect is the capacitor (100) based on the first or second aspect. In the third aspect, at least a part of the first ridge portion (144) is exposed from the filling resin (160).

According to this aspect, in the gap (G1) between the first bus bar (120) and the insulating member (140), the rising of the liquid resin due to the capillary action of the liquid resin is prevented, and it is possible to prevent the occurrence of a positional deviation due to leakage of the liquid resin to the outside of the capacitor (100) and adhesion of the filling resin (160) to a fastener (145) of the insulating member (140).

A fourth aspect is the capacitor (100) based on any one of the first to third aspects. In the fourth aspect, the insulating member (140) further includes at least one projection (146) disposed farther from the filling resin (160) than the first ridge portion (144).

According to this aspect, it is possible to prevent warpage of the first bus bar (120) and a positional deviation of the fastener (145) of the insulating member (140).

A fifth aspect is the capacitor (100) based on the fourth aspect. In the fifth aspect, an area of a part of the projection (146) that is in contact with the first bus bar (120) is less than or equal to an area of a part of the first ridge portion (144) that is in contact with the first bus bar (120).

According to this aspect, it is possible to prevent warpage of the first bus bar (120) and the insulating member (140), and further prevent a positional deviation of the fastener (145) of the insulating member (140).

A sixth aspect is the capacitor (100) based on any one of the first to fifth aspects. In the sixth aspect, the insulating member (140) further includes a second facing surface (147) and a second ridge portion (148), the second facing surface (147) facing the second bus bar (130) with a gap (G2) disposed between the second facing surface (147) and the second bus bar (130), the second ridge portion (148) being in contact with the second bus bar (130).

According to this aspect, when the liquid resin is filled in the process of manufacturing the capacitor (100), it is possible to prevent the liquid resin from rising due to the capillary action of the liquid resin in the gap (G2) between the second bus bar (130) and the insulating member (140).

What is claimed is:

1. A capacitor comprising:
a capacitor element;
a first bus bar and a second bus bar that are connected to the capacitor element;
an insulating member disposed between the first bus bar and the second bus bar;
a case housing the capacitor element; and
a filling resin filled in the case,
wherein:
a part of each of the first bus bar, the second bus bar, and the insulating member is exposed from the filling resin, and
the insulating member includes a first facing surface and a first ridge portion, the first facing surface facing the first bus bar with a gap disposed between the insulating member and the first bus bar, the first ridge portion being in contact with the first bus bar.

2. The capacitor according to claim 1, wherein the first ridge portion extends parallel to a surface of the filling resin, the surface being not in contact with the case.

3. The capacitor according to claim 1, wherein at least a part of the first ridge portion is exposed from the filling resin.

4. The capacitor according to claim 1, wherein the insulating member further includes at least one projection disposed farther from the filling resin than the first ridge portion.

5. The capacitor according to claim 4, wherein an area of a part of the projection that is in contact with the first bus bar is less than or equal to an area of a part of the first ridge portion that is in contact with the first bus bar.

6. The capacitor according to claim 1, wherein the insulating member further includes a second facing surface and a second ridge portion, the second facing surface facing the second bus bar with a gap disposed between the insulating member and the second bus bar, the second ridge portion being in contact with the second bus bar.
